(19) United States
(12) Patent Application Publication
(10) Pub. No.: US 2023/0394573 A1
(43) Pub. Date: Dec. 7, 2023

(54) USED VEHICLE TRADING SUPPORT SYSTEM AND METHOD

(71) Applicant: TOYOTA JIDOSHA KABUSHIKI KAISHA, Toyota-shi Aichi-ken (JP)

(72) Inventor: Kyosuke Terada, Toyota-shi Aichi-ken (JP)

(73) Assignee: TOYOTA JIDOSHA KABUSHIKI KAISHA, Toyota-shi Aichi-ken (JP)

(21) Appl. No.: 18/129,987

(22) Filed: Apr. 3, 2023

(30) Foreign Application Priority Data
Jun. 6, 2022 (JP) 2022-091435

(51) Int. Cl. G06Q 40/04; G06Q 10/20

(52) U.S. Cl. CPC G06Q 40/04; G06Q 10/20

(57) ABSTRACT

The used vehicle trading support system of the present disclosure supports trading of a vehicle owner's owned vehicle as a used vehicle by utilizing vehicle information acquired from a plurality of vehicles, discloses vehicle information of the owned vehicle as used vehicle information, and determines whether or not trading is established between the vehicle owner and a purchase applicant who desires to purchase the owned vehicle by browsing the disclosed vehicle information, determines maintenance details to be applied to the owned vehicle, and when it is determined that trading of the owned vehicle is established, notifies the maintenance-related business operator related to maintenance of the owned vehicle of the determined maintenance details.

### CROSS-REFERENCE TO RELATED APPLICATION

This application claims priority to Japanese Patent Application No. 2022-091435 filed on Jun. 6, 2022, incorporated herein by reference in its entirety.

### BACKGROUND

### 1. Technical Field

The present disclosure relates to a used vehicle trading support system and method for supporting trading of used vehicles.

### 2. Description of Related Art

A used vehicle distribution system including a server that supports trading transactions of used vehicles between an individual seller terminal and a buyer terminal is known (see, for example, Japanese Unexamined Patent Application Publication No. 2015-036843 (JP 2015-036843 A)). The server of the used vehicle distribution system includes: business negotiation support means that supports business negotiations between the seller terminal and the buyer terminal based on registered used vehicle information for sale, seller information, used vehicle information for purchase, and buyer information; and delivery support means. When an approach request is received from the seller terminal or the buyer terminal, the business negotiation support means transmits a business negotiation screen through which messages can be exchanged with each other to the seller terminal and the buyer terminal to start the business negotiation. When the business negotiation between the seller and the buyer is established, the delivery support means generates delivery request information, transmits the delivery request information to a partner terminal, and requests the partner to perform a procedure for delivery. The partner that has received the request for the procedure receives the vehicle from the seller, confirms the condition of the vehicle to fix the maintenance content, and arranges the parts and the like necessary for the maintenance. After carrying out the maintenance including the replacement of parts and the like, the partner delivers the vehicle to the buyer.

### SUMMARY

However, in the conventional used vehicle distribution system described above, if the vehicle is not delivered from the seller to the partner, the content of the maintenance to be performed on the vehicle cannot be determined and the parts and the like necessary for the maintenance cannot be arranged. Therefore, in the used vehicle distribution system described above, it is difficult to shorten the time from when the business negotiation between the seller and the buyer is established until when the vehicle is actually delivered to the buyer.

In view of this, the main object of the present disclosure is to shorten the time from when trading is established between a vehicle owner who intends to sell his/her owned vehicle as a used vehicle and a purchase applicant who wishes to purchase the owned vehicle, until the owned vehicle of the vehicle owner is delivered to the purchase applicant.

A used vehicle trading support system of the present disclosure is a used vehicle trading support system for supporting trading of an owned vehicle of a vehicle owner as a used vehicle by utilizing vehicle information acquired from a plurality of vehicles. The used vehicle trading support system includes: an information disclosure unit for disclosing the vehicle information of the owned vehicle as used vehicle information; a trading establishment determination unit for determining whether the trading of the owned vehicle is established between the vehicle owner and a purchase applicant who wishes to purchase the owned vehicle by browsing the disclosed vehicle information; a maintenance content decision unit for deciding maintenance content to be applied to the owned vehicle, based on the vehicle information of the owned vehicle; and a maintenance content notification unit for notifying a maintenance-related business operator involved in maintenance of the owned vehicle of the maintenance content decided by the maintenance content decision unit, when the trading establishment determination unit determines that the trading of the owned vehicle is established.

A used vehicle trading support method of the present disclosure is a used vehicle trading support method for supporting trading of an owned vehicle of a vehicle owner as a used vehicle by utilizing vehicle information acquired from a plurality of vehicles. The used vehicle trading support method includes: disclosing the vehicle information of the owned vehicle as used vehicle information; determining whether the trading of the owned vehicle is established between the vehicle owner and a purchase applicant who wishes to purchase the owned vehicle by browsing the disclosed vehicle information; deciding maintenance content to be applied to the owned vehicle in response to a determination that the trading of the owned vehicle is established; and notifying a maintenance-related business operator involved in maintenance of the owned vehicle of the decided maintenance content.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating a used vehicle trading support system according to the present disclosure;

FIG. 2 is a flowchart illustrating a procedure for supporting a used vehicle trading by the used vehicle trading support system according to the present disclosure; and

FIG. 3 is a flow chart showing a process of determining the maintenance content in the step S100 of FIG. 2.

### DETAILED DESCRIPTION OF EMBODIMENTS

Embodiments of the present disclosure will now be described with reference to the drawings.

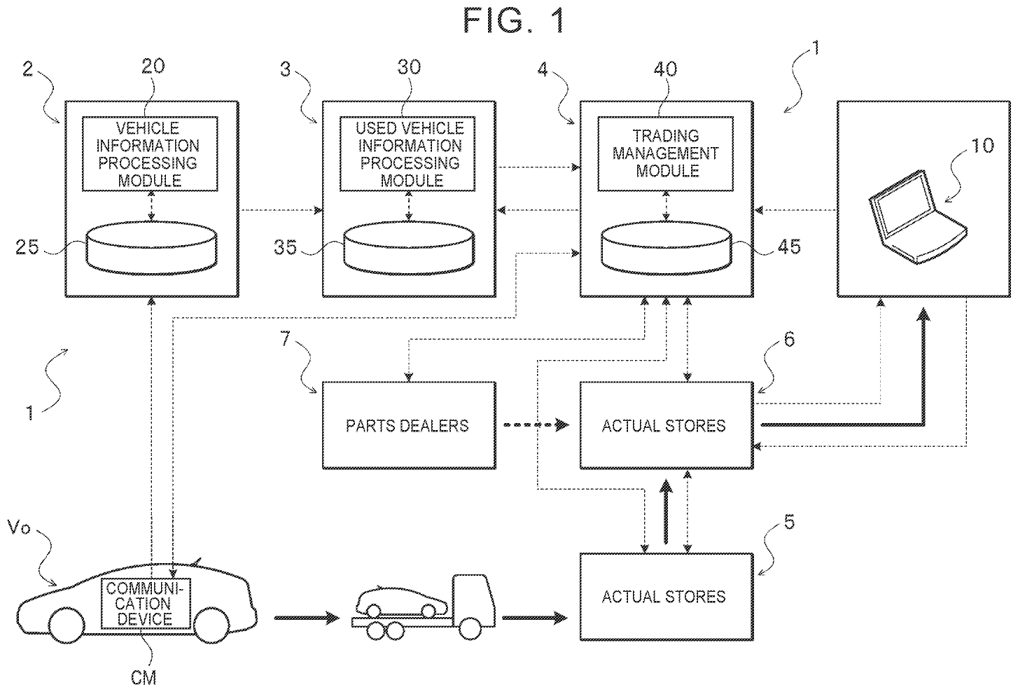

FIG. 1 is a schematic configuration diagram illustrating a used vehicle trading support system 1 according to the present disclosure. The used vehicle trading support system 1 shown in FIG. 1 can match a vehicle owner who is considering the sale of his/her owned vehicle Vo with a person who wishes to purchase the owned vehicle Vo. As illustrated in FIG. 1, the used vehicle trading support system 1 includes a vehicle information management server 2, a used vehicle information management server 3, and a used vehicle trading management server 4. The vehicle information management server 2 and the used vehicle information management server 3 can exchange information with each other via, for example, a network such as the Internet or a dedicated line. The used vehicle information management server 3 and the used vehicle trading management server 4 can exchange information with each other via, for example, a network such as the Internet or a dedicated line. Further, the used vehicle trading management server 4 is capable of exchanging information with a terminal or a server (not shown) installed in an actual store 5, 6, or a part handling store 7 of a series, which is a dealer or the like of a series that handles used vehicles, via a network such as the Internet or a dedicated line.

The vehicle-information managing server 2 is a computer including a CPU, ROM, RAM, an input/output device, a communication module, and the like, and is installed and managed by, for example, an automobile manufacturer in the present embodiment. The vehicle information management server 2 includes a vehicle information processing module constructed by cooperation of hardware such as a CPU and a ROM, RAM and various programs installed in advance, and a storage device 25. The vehicle information processing module 20 acquires vehicle information from a plurality of vehicles registered in the vehicle information management server 2, and stores the vehicle information in the storage device 25.

Vehicle information acquired from a vehicle corresponding to the vehicle information processing module 20 includes information such as, for example, a vehicle number or a vehicle identification number, the current vehicle owner's name, a contact address of the vehicle owner's name, the owner's itinerant, a manufacturer's name, a vehicle name, a model, a year, a body color, a driving system, a transmission type, a handle position, a displacement, a fuel type, a capacity, a number of doors, a body type, a grade name, individual equipment, a vehicle photograph, a car inspection presence, a ownership form, a maintenance record, a travel distance, an accident history, body data, and a travel record. Such vehicle information is acquired as big data from a plurality of vehicles in order to investigate a cause of a defect occurring in the vehicle, optimize specifications of parts and vehicle systems, analyze traffic flow, road surface conditions, behavior correction, and the like, and improve efficiency of a car sharing business.

The storage device 25 of the vehicle information management server 2 stores a database in which the vehicle information is stored for each of a plurality of vehicles. That is, individual ID are assigned to each of the plurality of vehicles registered in the vehicle information management server 2, and the vehicle information is stored in the data base in association with ID. Further, the database is updated every time a new vehicle is registered in the vehicle information management server 2. Further, in the present embodiment, the vehicle information processing module 20 periodically requests the in-vehicle communication device CM (see FIG. 1) mounted on the vehicle such as the owned vehicle Vo to transmit the vehicle information, and updates the data base based on the vehicle information transmitted from the in-vehicle communication device CM.

Further, the vehicle information processing module 20 periodically transmits, to the in-vehicle communication device CM of the vehicle registered in the vehicle information management server 2, an information disclosure intention confirmation notification for confirming whether or not the vehicle owner is willing to disclose his/her owned vehicle Vo as a used vehicle that is likely to be sold. When the vehicle owner confirms that the information disclosure intention confirmation notification is received, if the vehicle owner wants to sell the owned vehicle Vo or considers that the owned vehicle Vo may be sold depending on the condition, the vehicle owner can return (transmit) a reply (notification) to the vehicle information management server 2 indicating that the vehicle owner agrees to the disclosure as a used vehicle with the possibility of selling the owned vehicle Vo. In addition, the vehicle owner can voluntarily transmit, from the in-vehicle communication device CM or the like, a notification indicating that the vehicle owner agrees to the disclosure as a used vehicle in which the owned vehicle Vo is likely to be sold, to the vehicle information management server 2 regardless of whether or not the notification is made from the vehicle information management server 2.

When the vehicle information processing module 20 (the vehicle information management server 2) receives, from the vehicle owner, a notification indicating that the vehicle owner agrees to the disclosure of the owned vehicle Vo as a used vehicle that may be sold, the vehicle information of the owned vehicle Vo is transmitted to the used vehicle information management server 3. When the vehicle owner does not intend to sell the owned vehicle Vo when the reception of the information disclosure intention confirmation notification is confirmed, the vehicle owner can prohibit the disclosure of the owned vehicle Vo by notifying the vehicle information management server 2 of this fact or ignoring the information disclosure intention confirmation notification. In addition, the information-disclosure intention confirmation notification may be transmitted not only to the in-vehicle communication device CM but also to, for example, the mail address of the registered vehicle owner.

The used vehicle information management server 3 is a computer including a CPU, ROM, RAM, an input/output device, a communication module, and the like, and is installed and managed by, for example, an automobile manufacturer in the present embodiment. The used vehicle information management server 3 includes a used vehicle information processing module 30 constructed by cooperation of hardware such as a CPU and a ROM, RAM and various programs installed in advance, and a storage device 35. The used vehicle information processing module 30 stores the vehicle information transmitted from the vehicle information management server 2 in the storage device 25. Further, the used vehicle information processing module 30 acquires (collects) used vehicle information posted on the used vehicle information sites of the company and other companies, and transaction information of the used vehicle in a so-called auction, and stores the acquired information together with the information of the transaction established via the used vehicle trading support system 1. The storage device 35 of the used vehicle information management server 3 stores a vehicle information database in which the vehicle information is stored, and a market transaction price database in which the used vehicle information, transaction information, and information on trading established via the used vehicle trading support system 1 are stored.

Further, in response to the reception of the vehicle information from the vehicle information management server 2, the used vehicle information processing module calculates the reference remaining value of the owned vehicle Vo that the vehicle owner is considering to sell, based on the received vehicle information and the information stored in the market exchange rate database. The used vehicle information processing module 30 (used vehicle information management server 3) calculates a reference residual value of the owned vehicle Vo, and then transmits the calculated reference residual value and vehicle information of the owned vehicle Vo to the used vehicle trading management server 4. In addition, the used vehicle information processing module 30 determines, based on the vehicle information from the vehicle information management server 2, the maintenance content to be performed prior to the delivery of the owned vehicle Vo to the next owner.

The used vehicle trading management server 4 is a computer including a CPU, ROM, RAM, an input/output device, a communication module, and the like, and is installed and managed by, for example, an automobile manufacturer in the present embodiment. The used vehicle trading management server 4 includes a trading management module 40 constructed by cooperation of hardware such as a CPU and a ROM, RAM and various programs installed in advance, and a storage device 45. The trading management module 40 performs, in addition to inventory management of a used vehicle to be sold, such as a so-called authorized used vehicle or a trade-in vehicle, management of a used vehicle information website of the company, and the like, an intermediation process of trading the owned vehicle Vo which the vehicle owner is considering to sell.

The trading management module 40 of the used vehicle trading management server 4, upon receiving the vehicle information and the reference residual value of the owned vehicle Vo that the vehicle owner is considering to sell from the used vehicle information management server 3, stores the received vehicle information and the reference residual value in the storage device 45, and posts (publishes) the owned vehicle Vo as a sellable vehicle for a predetermined posting period (predetermined period) on the company's used vehicle information website. As a result, a large number of unspecified viewers can access the vehicle information and the like of the owned vehicle Vo of the used vehicle information web site on a time-limited basis via a network such as the Internet. A person who wishes to purchase the owned vehicle Vo can apply for purchase from his/her terminal 10, such as a personal computer or a smart phone, on the used vehicle information website, and present the desired purchase price to the used vehicle trading management server 4. As described below, the used vehicle trading support system 1 matches the vehicle owner who is considering the sale of the owned vehicle Vo with the purchase applicant who desires to purchase the owned vehicle Vo.

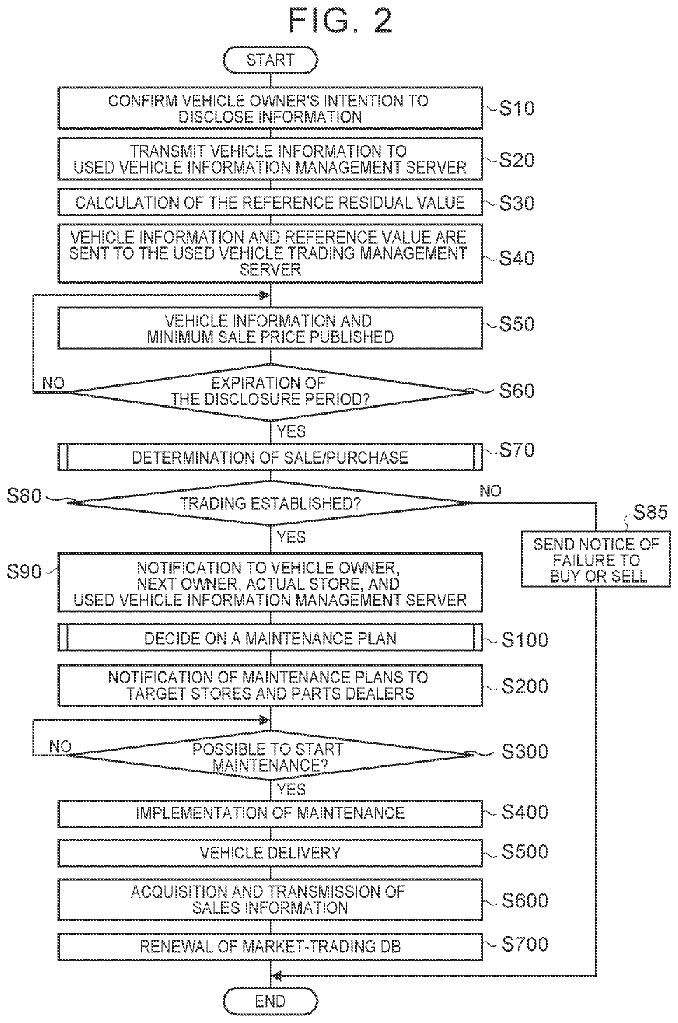

FIG. 2 is a flowchart illustrating a procedure for assisting a used vehicle trading by the used vehicle trading support system 1. The series of processing illustrated in FIG. 2 is executed in cooperation with the vehicle information processing module 20 of the vehicle information management server 2, the used vehicle information processing module of the used vehicle information management server 3, and the trading management module 40 of the used vehicle trading management server 4.

As shown in the figure, when the vehicle information processing module 20 receives a notification from the vehicle owner registered in the vehicle information management server 2 that the vehicle owner agrees to the disclosure of the owned vehicle Vo as a used vehicle that may be sold (step S10), the vehicle information of the owned vehicle Vo is transmitted to the used vehicle information management server 3 (step S20). When the vehicle information is transmitted from the vehicle information management server 2 to the used vehicle information management server 3, the used vehicle information processing module 30 calculates the reference residual value of the owned vehicle Vo on the basis of the received vehicle information and information stored in the market exchange rate database (step S30).

In the step S30, the used vehicle information processing module 30 first acquires information (basic information) such as the elapsed years of the owned vehicle Vo, the travel distance, the degree of individual equipment (for example, the presence or absence of a genuine manufacturer option such as a sunroof), the presence or absence of a repair history, the presence or absence of a maintenance notebook, and the condition of the interior and exterior from the vehicle information from the vehicle information management server 2, and calculates the base remaining value from the information to be acquired and the predetermined index. Further, in the step S30, the used vehicle information processing module 30 determines whether or not the target owned vehicle Vo is a popular vehicle in the market, a limited vehicle with a high demand, or an excessive vehicle in stock, based on information on a transaction result and a distribution state in the market of the same vehicle type as the owned vehicle Vo stored in the market exchange rate database, and calculates an addition amount or a subtraction amount according to the determination result. Further, in the step S30, the used vehicle information processing module 30 determines whether or not maintenance exceeding the standard-level maintenance is required in delivering the owned vehicle Vo to the next owner on the basis of the information (health condition) such as the degree of restoration and the condition of the interior and exterior obtained from the vehicle information from the vehicle information management server 2, and calculates a subtracted amount according to the determination result. The used vehicle information processing module 30 calculates a reference residual value by adding an addition amount or a subtraction amount based on a transaction result or the like in the market and a subtraction amount based on a health state of the vehicle to the base residual value.

Subsequently, the used vehicle information processing module 30 transmits the vehicle information from the vehicle information management server 2 and the reference residual price calculated for the target owned vehicle Vo to the used vehicle trading management server 4 (step S40). When vehicle information or the like is transmitted from the used vehicle information management server 3 to the used vehicle trading management server 4, the trading management module 40 creates a web page of the target owned vehicle Vo on the basis of the vehicle information from the used vehicle information management server 3 and the reference residual value, and posts (publishes) the web page as used vehicle information by dividing the period into its own used vehicle information website (step S50). In the step S50, the reference residual value calculated by the used vehicle information processing module 30 is displayed on the web page as the lowest sale price of the owned vehicle Vo. As a result, a large number of unspecified viewers can access the vehicle information and the minimum sale price of the owned vehicle Vo disclosed on the used vehicle information website for a limited period of time from when the web page of the owned vehicle Vo is posted on the used vehicle information website until the posting period (predetermined period) elapses (step S60: NO).

The purchaser who wants to purchase the owned vehicle Vo by browsing the vehicle information or the like disclosed on the used vehicle information website can apply for the purchase of the owned vehicle Vo from the used vehicle information website to the used vehicle trading management server 4 on the used vehicle information website from the terminal 10 and present the desired purchase price within the above-described posting period. Further, in the present embodiment, when a plurality of purchase seekers appear within the posting period, the trading management module 40 notifies each purchase seeker of whether or not the maximum amount of the desired purchase price and the maximum amount are presented. As a result, the purchaser who wishes to purchase the owned vehicle Vo can present the desired purchase price exceeding the maximum amount to the used vehicle trading management servers 4. That is, in the used vehicle trading support system 1, the desired purchase price is determined in the auction format.

When the posting period elapses after the owned vehicle Vo is posted on the used vehicle information website (step S60: YES), the trading management module 40 determines whether or not the trading of the owned vehicle Vo is established after the status of the owned vehicle Vo on the used vehicle information website is set to “under business negotiation” (step S70). In step S70, the trading management module 40 first determines whether or not there is a person who wishes to purchase the owned vehicle Vo, and when there is no person who wishes to purchase the owned vehicle Vo, determines that the trading of the owned vehicle Vo has not been established (step S80: NO).

When it is determined that the sale and purchase of the owned vehicle Vo has not been established, the trading management module 40 transmits a notification indicating that the sale and purchase of the owned vehicle Vo has not been established, to the in-vehicle communication device CM of the owned vehicle Vo, the e-mail address of the vehicle owner, and the like, deletes the web page of the owned vehicle Vo from the used vehicle information web site (step S85), and terminates the series of processes in FIG. 2 at that time. In this case, after receiving the notification from the trading management module 40, the vehicle owner notifies the vehicle information management server 2 again that he/she agrees to disclose the vehicle information or the like, or cancels the sale of the owned vehicle Vo.

On the other hand, if there is a person who wishes to purchase owned vehicles Vo, in the step S70, the trading management module 40 determines whether there are a plurality of persons who wish to purchase. When the plurality of purchase applicants desire to purchase owned vehicles Vo, the trading management module 40 extracts the maximum amount of the desired purchase price presented by the plurality of purchase applicants, sets the purchase applicant who has presented the maximum amount as the purchase scheduled person, and sets the maximum amount as the desired purchase price of the purchase scheduled person. In addition, in a case where there is one person who wishes to purchase, the trading management module 40 determines the one person as the prospective purchaser, and determines the presented amount as the desired purchase price of the prospective purchaser.

Further, in S70 of steps, after setting the reply period, the trading management module 40 transmits a notification (sale availability confirmation notification) for confirming the sale availability including the fact that there is a person who wishes to purchase the owned vehicle Vo and the desired purchase price to the vehicle owner, i.e., the in-vehicle communication device CM of the owned vehicle Vo. Further, after setting the reply period, the trading management module 40 transmits a notification (purchase permission confirmation notification) for confirming whether or not the purchase is permitted, including the fact that the owner-vehicle Vo can be purchased and the desired purchase price, to the scheduled purchaser (e.g., the mail address). Further, in a case where there is a plurality of purchase applicants, the trading management module 40 transmits a notification notifying the purchase applicant who has not become the purchase scheduled person that the person has not become the purchase scheduled person.

If the reply is not received from either or both of the vehicle owner and the prospective purchaser until the reply time limit elapses, the trading management module 40 determines that the trading of the owned vehicle Vo cannot be established between the vehicle owner and the prospective purchaser (step S80: NO). In addition, if one of the vehicle owner and the prospective purchaser does not agree to sell or purchase the owned vehicle Vo, the trading management module 40 determines that the trading of the owned vehicle Vo cannot be established between the vehicle owner and the prospective purchaser (step S80: NO). In these cases, the trading management module 40 sends a notification to the vehicle owner and the prospective purchaser that the trading of the owned vehicle Vo has not been established, and deletes the web page of the owned vehicle Vo from the used vehicle information website (step S85), and terminates the series of processes of FIG. 2 at that time.

On the other hand, if the vehicle owner agrees to sell the owned vehicle Vo and the prospective purchaser agrees to purchase the owned vehicle Vo, the trading management module 40 determines that the trading of the owned vehicle Vo is established between the vehicle owner and the prospective purchaser (step S80: YES). Hereinafter, the planned purchaser who has agreed to purchase the owned vehicles Vo will be referred to as the “next owner”. In this case, the trading management module 40 selects the nearest actual store 5 in charge of the procedure with the vehicle owner and the nearest actual store 6 in charge of the procedure with the next owner and the maintenance of the owned vehicle Vo, and transmits the required notification to the vehicle owner, the next owner, the actual stores 5 and 6, and the used vehicle information management server 3 (the used vehicle information processing module 30), and deletes the web page of the owned vehicle Vo from the used vehicle information web site (step S90).

In the step S90, the trading management module 40 transmits a notification including the fact that the sale and purchase of the owned vehicle Vo has been completed to the vehicle owner (the in-vehicle communication device CM of the owned vehicle Vo or the like), the flow of the procedure in the actual store 5, and the like, and transmits a notification including the fact that the sale and purchase of the owned vehicle Vo has been completed to the next owner (e-mail address or the like), the flow of the procedure in the actual store 6, and the like. In addition, in the step S90, the trading management module 40 transmits a notification including required information such as information on the vehicle owner and the next owner, vehicle information on Vo of the owned vehicle, and a desired purchase price to the terminals of the actual stores 5 and 6. Further, in the step S90, the trading management module 40 transmits, to the used vehicle information management server 3 (used vehicle information processing module 30), information on the next owner, information on the actual store 6 in charge of the procedure with the next owner, a notification including a request for determining the maintenance content of the owned vehicle Vo, and the like.

When the notification is transmitted to the related destination in the step S90, a sales contract for the owned vehicle Vo is made between the vehicle owner and the actual store 5, and the owned vehicle Vo is conveyed from the vehicle owner's home or the like to the actual store 6 through the actual store 5. During this time, necessary information is exchanged between the actual store 5 and the actual store 6 as appropriate. Further, a sales contract for Vo of the owned vehicles is made between the next owner and the actual store 6. Further, the used vehicle information processing module 30 of the used vehicle information management server 3 determines the maintenance content to be applied to the owned vehicle Vo prior to delivery based on the vehicle information or the like of the owned vehicle Vo (step S100).

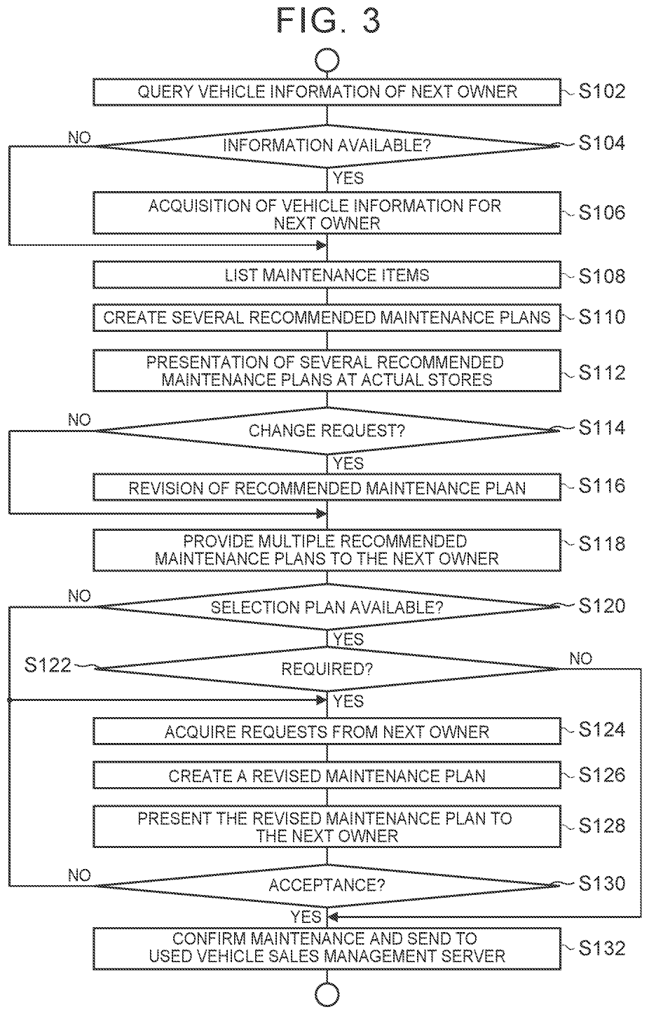

FIG. 3 is a flow chart illustrating a process of determining the maintenance content of the owned vehicle Vo in the step S100. As shown in the drawing, the used vehicle information processing module 30 first inquires of the vehicle information management server 2 whether or not there is vehicle information associated with the next owner, that is, vehicle information about the vehicle that the next owner currently owns or previously owns, based on the information about the next owner transmitted from the used vehicle trading management server 4 (step S102). When the next owner is registered in the vehicle information management server 2 and the vehicle information associated with the next owner is present (step S104: YES), the used vehicle information processing module 30 acquires the vehicle information of the next owner from the vehicle information management server 2 (vehicle information processing module 20) (step S106). In addition, if there is no vehicle-information associated with the next owner (step S104: NO), the process of step S106 is skipped.

Subsequently, the used vehicle information processing module 30 lists maintenance items based on the vehicle information of the owned vehicle Vo (step S108). In the step S108, the used vehicle information processing module 30 lists (extracts) essential maintenance items, maintenance items to be carried out in the medium term, maintenance items to be carried out in the long term, components to be replaced (including consumables), components to be recommended to be replaced in the medium term, components to be replaced in the long term, and components to be replaced in the long term, etc., based on information such as type, year type, vehicle inspection presence/absence, maintenance record, travel distance, accident history, and travel record included in the vehicle information.

Further, when acquiring the vehicle information associated with the next owner in step S106, the used vehicle information processing module 30, in step S108, based on the driving tendency obtained from the vehicle information of the next owner, essential maintenance items and recommended maintenance items, parts to be replaced, parts recommended replacement lists the like. In the present embodiment, the upper limit use threshold (allowable use period) is predetermined for each component for a large number of components used in a plurality of vehicles registered in the vehicle information management server 2, and the used vehicle information processing module 30 specifies a component or the like that needs to be replaced based on the upper limit use threshold.

After listing the maintenance items, the used vehicle information processing module 30 creates a plurality of recommended maintenance plans (recommended maintenance details) to be presented to the next owner according to predetermined constraints (step S110). Multiple recommended maintenance plans are prepared to specify, for example, essential maintenance items, recommended maintenance items to be implemented, parts to be replaced without fail, parts to be replaced, parts to be replaced, and differences from standard maintenance costs for multiple periods, such as short, medium, and long periods. Further, the used vehicle information processing module 30 sets a response time limit and presents the plurality of recommended maintenance plans created in the step S110 to the actual store 6 in charge of the maintenance of the owned vehicle Vo prior to the presentation to the next owner (step S112). In the step S112, the data indicating the plurality of recommended maintenance plans may be transmitted from the used vehicle information management server 3 to the terminal of the actual store 6 via the used vehicle trading management server 4, or may be directly transmitted from the used vehicle information management server 3 to the terminal of the actual store 6.

In the actual store 6 that has received the plurality of recommended maintenance plans, a plurality of recommended maintenance plans are examined based on the vehicle information of the owned vehicle Vo received in the step S90, the characteristics of the area where the next owner resides, and the like. The person in charge of the actual store 6 transmits, to the used vehicle information management server 3 directly or via the used vehicle trading management server 4, a notification indicating the presence or absence of changes in a plurality of recommended maintenance plans, the contents of the changes, i.e., the proposal from the actual store 6, and the like within the response time limit. Upon receiving the notification from the actual store 6, the used vehicle information processing module 30 of the used vehicle information management server 3 determines whether or not there is a change request (suggestion) from the actual store 6 (step S114). When at least one of the plurality of recommended maintenance plans is requested to be changed from the actual store 6 side (step S114: YES), the used vehicle information processing module 30 corrects at least one of the plurality of recommended maintenance plans according to the change request from the actual store 6 side (step S116). In addition, when a plurality of recommended maintenance plans are not required to be changed by the actual store 6 (step S114: NO), the process of step S116 is skipped.

After the process of step S114 or S116, the used vehicle information processing module 30 sets a response time limit and presents a plurality of recommended maintenance plans created at step S110 or modified at step S116 to the next owner (step S118). In the step S118, the data indicating the plurality of recommended maintenance plans may be transmitted from the used vehicle information management server 3 to the terminal of the next owner via the used vehicle trading management server 4, or may be directly transmitted from the used vehicle information management server 3 to the terminal 10 of the next owner. Upon receiving the plurality of recommended maintenance plans, the next owner notifies the used vehicle information management server 3 of the plan selected by the owner of the plurality of recommended maintenance plans directly or via the used vehicle trading management server 4 within the response time limit set by the used vehicle information processing module 30.

Further, the next owner may request the revision (review) of the recommended maintenance plan according to his/her request, or may request the used vehicle information processing module 30 side to create a new recommended maintenance plan according to the conditions (requests) set by the next owner instead of selecting the recommended maintenance plan. In the present embodiment, the next-generation owner can notify the used vehicle information processing module 30 as his/her own request of the prevention maintenance period, which is the shortest period (for example, one year) in which the owned vehicle Vo is desired to be used without trouble, the upper limit (reduction request or allowable increase amount) of the cost required for maintenance, the desired maintenance item (additional component replacement), and the like.

When receiving the notification from the next owner, the used vehicle information processing module 30 of the used vehicle information management server 3 determines whether any one of the plurality of recommended maintenance plans is selected by the next owner (step S120). When any one of the plurality of recommended maintenance plans is selected by the next owner (step S120: YES), the used vehicle information processing module 30 determines whether or not a request for maintenance (change request) is notified from the next owner (step S122). When a request for maintenance is notified from the next owner (step S122: YES), the used vehicle information processing module 30 acquires a request from the next owner (step S124), and creates a modified maintenance plan based on the recommended maintenance plan selected by the next owner and the request from the next owner (step S126).

When none of the plurality of recommended maintenance plans is selected by the next owner (step S120: NO), the used vehicle information processing module 30 acquires a request from the next owner (step S124), and creates a modified maintenance plan based on the maintenance items listed in the step S108 and the request from the next owner (step S126). If the request regarding maintenance includes a preventive maintenance period from the next owner, the used vehicle information processing module 30 extracts, in the step S126, maintenance items for maintaining Vo of the owned vehicles in a trouble-free manner during the preventive maintenance period designated by the next owner and components that need to be replaced within the preventive maintenance period, and includes the extracted maintenance items and the replacement of the extracted components in the corrective maintenance plan.

Further, the used vehicle information processing module 30 sets a response time limit and presents the modified maintenance plan created in the step S126 to the next owner (step S128). In the step S128, the data indicating the correction maintenance plan may be transmitted from the used vehicle information management server 3 to the terminal 10 of the next owner via the used vehicle trading management server 4, or may be directly transmitted from the used vehicle information management server 3 to the terminal 10 of the next owner. Upon receipt of the revised maintenance plan, the next owner confirms the content of the revised maintenance plan, accepts the revised maintenance plan, or transmits a request to change the revised maintenance plan to the used vehicle information management server 3 directly or via the used vehicle trading management server 4.

When the revised maintenance plan is not accepted by the next owner and a request (change request) regarding the revised maintenance plan is notified (step S130: NO), the used vehicle information processing module 30 executes the process of step S124-S128 again. On the other hand, if a notification is received from the next owner to accept the revised maintenance plan (step S130: YES), the used vehicle information processing module determines the content of the revised maintenance plan created in the step S126 as the final maintenance content, and transmits the determined maintenance content to the used vehicle trading management server 4 (step S132). Further, when any one of the plurality of recommended maintenance plans is selected by the next owner (step S120: YES) and a request for maintenance is not notified from the next owner (step S122: NO), the used vehicle information processing module 30 determines the content of the recommended maintenance plan selected by the next owner as the final maintenance content, and transmits the determined maintenance content to the used vehicle trading management server 4 (step S132).

As shown in FIG. 2, the trading management module 40 of the used vehicle trading management server 4 transmits the maintenance details of the owned vehicle Vo received from the used vehicle information management server 3 to the actual store 6 in charge of the maintenance of the owned vehicle Vo and the nearest part handling store 7 of the actual store 6 (step S200). In response to the reception of the maintenance content of the owned vehicle Vo, the actual store 6 prepares the maintenance work, and the part handling store 7 prepares the components designated in the maintenance content from the used vehicle information management server 3 and dispatches them to the actual store 6. Further, in the actual store 6, when both of the owned vehicle Vo from the actual store 5 and the components from the part handling store 7 arrive (step S300: YES), the maintenance of the owned vehicle Vo according to the maintenance content determined in the step S100 is performed (step S400), and the owned vehicle Vo is delivered from the actual store 6 to the next owner after the completion of the maintenance (step S500).

After the delivery of the owned vehicle Vo to the next owner (new owner), information on the sale of the owned vehicle Vo such as the sale price including the final expenses and the like is transmitted from the actual stores 5 and 6 to the used vehicle trading management server 4, and the trading management module 40 transmits the information acquired from the actual stores 5 and 6 to the used vehicle information management server 3 (step S600). Further, the used vehicle information processing module 30 of the used vehicle information management server 3 stores the information from the used vehicle trading management server 4 in the market transaction rate database in association with the vehicle information of the owned vehicle Vo (step S700). As a result, Vo of the owned vehicles, that is, the trading of the used vehicles is completed under the support of the used vehicle trading support system 1.

As described above, in the used vehicle trading support system 1, the trading management module 40 of the used vehicle trading management server 4 as the information disclosure unit, when the vehicle information processing module 20 of the vehicle information management server 2 confirms that the vehicle owner is willing to disclose the owned vehicle Vo as the used vehicle (step S10), the vehicle information of the owned vehicle Vo is disclosed (step S50-S60). Further, the trading management module 40 as a trading establishment determination unit determines whether or not trading of the owned vehicle Vo is established between the vehicle owner and the purchase applicant who wants to purchase the owned vehicle Vo by browsing the disclosed vehicle information (step S70-S80). Further, the used vehicle information processing module 30 of the used vehicle information management server 3 as the maintenance content decision unit determines the maintenance content to be applied to the owned vehicle Vo based on the vehicle information of the owned vehicle Vo (step S100). Then, when it is determined that the sale and purchase of the owned vehicle Vo is established (step S80: YES), the transaction managing module as the maintenance content notification unit notifies the actual store 6 and the part handling store 7, which are maintenance-related businesses related to the maintenance of the owned vehicle Vo, of the maintenance content determined by the used vehicle information processing module 30 (step S200).

Thus, in the actual store 6, preparation for maintenance can be started prior to delivery of the owned vehicle Vo from the vehicle owner (the actual store 5), and the part handling store 7 can start arrangement of the replacement component or the like prior to conveyance of the owned vehicle Vo to the actual store 6. Therefore, the actual store 6 can promptly complete the required maintenance after the owned vehicle Vo is delivered. As a consequence, it is possible to effectively utilize the period in which the owned vehicle Vo is in the hands of the vehicle owner, and to shorten the time from when the sale is completed between the vehicle owner and the purchase applicant until the owned vehicle Vo of the vehicle owner is actually delivered to the purchase applicant (the next owner).

In addition, when it is determined that the sale and purchase of the owned vehicle Vo is established (step S80: YES), the used vehicle information processing module acquires a request regarding maintenance from the next owner (step S118-S124), and determines the maintenance content based on the acquired request of the next owner (step S126-S132). As a result, maintenance can be performed on the owner-vehicle Vo according to the request of the next owner. In addition, by narrowing down the maintenance content according to the request of the next owner, it is possible to further shorten the time required for maintenance and, in turn, the time until the owned vehicle Vo is delivered to the next owner after the sale and purchase is completed.

Further, the used vehicle information processing module 30 creates a plurality of recommended maintenance plans based on the vehicle information of the owned vehicle Vo, presents the plurality of recommended maintenance plans to the next owner, and determines the maintenance contents based on the request of the next owner with respect to the recommended maintenance contents (S118-S132). As a result, the maintenance performed on the owned vehicle Vo can be made in accordance with the request of the next owner, so that usability of the next owner in the used vehicle trading support system 1 can be further improved.

Further, in the used vehicle trading support system 1, the next owner can notify the used vehicle information processing module 30 of the preventive maintenance period of the owned vehicle Vo as his/her request, and the used vehicle information processing module 30 extracts a part or the like that needs to be replaced within the preventive maintenance period designated by the next owner, and includes the replacement of the extracted part or the like in the modified maintenance plan (step S126). As a result, the maintenance content can be determined more appropriately in accordance with the scheduled use period, the budget, and the like of Vo of the owned vehicles by the next owner.

Further, the used vehicle information processing module 30 presents the plurality of recommended maintenance contents to the maintenance-related business operator such as the actual store 6 and the part handling store 7 prior to the presentation to the next owner, acquires a change request from the maintenance-related business operator, and presents the recommended maintenance contents corrected based on the change request to the next owner (step S108-S118). Accordingly, it is possible to appropriately modify the recommended maintenance content created based on the vehicle information based on the opinion of the maintenance expert and make the recommended maintenance content more appropriate.

When there is vehicle information associated with the next owner (step S102, S104: YES), the used vehicle information processing module 30 extracts a part or the like that needs to be replaced based on the vehicle information of the next owner, and includes the extracted part or the like in the recommended maintenance plan (step S108-S110). As a result, it is possible to recommend replacement and maintenance of parts that may deteriorate within a relatively short period of time to the next owner in advance in consideration of the driving tendency of the next owner.

Further, in the used vehicle trading support system 1, the vehicle information processing module 20 of the vehicle information management server 2 as the confirmation unit checks whether or not the vehicle owner has an intention to disclose his/her owned vehicle Vo as a used vehicle that may be sold (step S10). In addition, when the vehicle information processing module 20 determines that the vehicle owner is willing to disclose the owned vehicle Vo as the used vehicle, the trading management module 40 of the used vehicle trading management server 4 as the information disclosure unit discloses the vehicle information of the owned vehicle Vo (step S50-S60). Further, the trading management module 40 of the used vehicle trading management server 4 as the trading establishment determination unit notifies the vehicle owner of the desired purchase price of the purchase applicant determined as the purchase scheduled person, and confirms whether or not the owned vehicle Vo can be sold from the vehicle owner who has received the notification of the desired purchase price (step S70).

As a result, the vehicle owner can know the purchase condition (desired purchase price) of the owned vehicle Vo without conducting business negotiations or the like by using the used vehicle trading support system 1 when the vehicle owner considers that the owned vehicle Vo may be sold depending on the condition. As a result, it is possible to improve usability of a vehicle owner who can become a seller of a used vehicle, and to realize smooth trading of the used vehicle.

Further, the used vehicle trading support system 1 includes a vehicle information processing module 20 that acquires vehicle information from a plurality of vehicles and stores the acquired vehicle information in a database in order to investigate a cause of a defect occurring in the vehicle, optimize specifications of the components and the vehicle system, and the like. This makes it possible to explore potential used cars by effectively utilizing vehicle information acquired as big data, and to revitalize the used car market and thus the new car market.

However, the vehicle information may be acquired only for the purpose of buying or selling a used vehicle, and the function of the vehicle information management server 2 (vehicle information processing module 20) may be integrated into the used vehicle information management server 3. Further, in the used vehicle trading support system 1, the function of the used vehicle information management server 3 (used vehicle information processing module 30) may be integrated into the vehicle information management server 2 or the used vehicle trading management server 4. Furthermore, the functions of the vehicle information management server 2, the used vehicle information management server 3, and the used vehicle trading management server 4 may be integrated into a single server. In addition, instead of the vehicle information management server 2 (vehicle information processing module 20), the used vehicle information management server 3 (used vehicle information processing module 30) may receive, from the vehicle owner, a notification indicating that the vehicle owner agrees to the disclosure as a used vehicle with the possibility of selling the owned vehicle Vo. In this case, the used vehicle information management server 3 (used vehicle information processing module 30) may request the vehicle information management server 2 (vehicle information processing module 20) to transmit the vehicle information of the owned vehicle Vo in response to the notification from the vehicle owner.

In addition, in the used vehicle trading support system 1, a plurality of recommended maintenance plans (recommended maintenance details) may be created without considering vehicle information of the next owner or a proposal of the maintenance-related business operator before it is determined that trading of the owned vehicle Vo has been completed, and after it is determined that trading of the owned vehicle Vo has been completed, the final maintenance details may be determined based on the vehicle information of the next owner, the request, and the proposal of the maintenance-related business operator. In this instance, the plurality of recommended maintenance plans may be posted on the webpage of the owned vehicle Vo in a step S50. Further, in the used vehicle trading support system 1, it may be determined that the trading of the owned vehicle Vo is established at a stage when both the vehicle owner and the next owner have concluded a contract (including a temporary contract) with the actual store 5 or 6.

As described above, the used vehicle trading support system of the present disclosure is a used vehicle trading support system (1) which supports trading of a vehicle owner's owned vehicle (Vo) as a used vehicle. An information disclosure unit (4,40, step S50-S60) for disclosing the vehicle information of the owned vehicle (Vo) as used vehicle information; A trading establishment determination unit (4,40, step S70-S80) for determining whether or not a purchase of the owned vehicle (Vo) is established between the vehicle owner and a purchase applicant who desires to purchase the owned vehicle (S100, S102-S132), and the vehicle information of the owned vehicle (Vo) When it is determined by the maintenance content decision unit (3, 30, step S100, S102-S132) for determining the maintenance content to be performed and the sales/purchase establishment determination unit (4, 40) that the sales/purchase of the owned vehicles (Vo) has been established (step S80: YES), The maintenance content decision unit (3, 30, step S70-S80) includes a maintenance content notification unit (4, 40, step S200) that notifies the maintenance-related business operator (6, 7) related to the maintenance of the owned vehicle (Vo) of the maintenance content determined.

The used vehicle trading support system of the present disclosure discloses the vehicle information of the vehicle owned by the vehicle owner as the used vehicle information, and determines whether or not the trading of the owned vehicle is established between the vehicle owner and the purchase applicant who wants to purchase the owned vehicle by browsing the disclosed vehicle information. Further, the used vehicle trading support system determines the maintenance content to be applied to the owned vehicle based on the vehicle information of the owned vehicle, and when it is determined that the sale and purchase of the owned vehicle is established, notifies the maintenance-related business operator related to the maintenance of the owned vehicle of the determined maintenance content. As a result, the maintenance-related business operator can start preparation for maintenance, arrangement of replacement parts, and the like prior to delivery of the owned vehicle from the vehicle owner, and thus can promptly complete necessary maintenance after the owned vehicle is delivered. As a result, it is possible to effectively utilize the period in which the vehicle owner is in hand of the vehicle owner, and to shorten the time from when the sale is completed between the vehicle owner and the purchase applicant until when the vehicle owner of the vehicle is actually delivered to the purchase applicant (the next owner).

In addition, when it is determined that the sale and purchase of the owned vehicle is established (step S80: YES), the maintenance content decision unit (3, 30) may acquire a request for maintenance from the next owner (step S118-S124), and determine the maintenance content based on the acquired request of the next owner (step S126-S132).

As a result, it is possible to perform maintenance on the owned vehicle according to the request of the next owner. In addition, by narrowing down the maintenance contents according to the request of the next owner, it is possible to further shorten the time required for maintenance and, in turn, the time required for the owner of the vehicle to be delivered to the next owner after the sale and purchase is completed.

Further, the maintenance content decision unit (3, 30) may create a recommended maintenance content based on the vehicle information of the owned vehicle (Vo), present the recommended maintenance content to the next owner, and determine the maintenance content based on the request of the next owner with respect to the recommended maintenance content (step S118-S132).

As a result, the maintenance content applied to the owned vehicle can be made in accordance with the request of the next owner, so that the usability of the next owner in the used vehicle trading support system 1 can be further improved.

Further, the request of the next owner may include a preventive maintenance period of the owned vehicle (Vo), and the maintenance content decision unit (3, 30) may extract a component that needs to be replaced within the preventive maintenance period designated by the next owner, and may include replacement of the extracted component in the maintenance content (step S126).

As a result, it is possible to more appropriately determine the maintenance content according to the scheduled use period, the budget, and the like of the owned vehicle by the next owner.

Further, the maintenance content decision unit (3, 30) may present the recommended maintenance content to the maintenance-related business operator (6, 7) prior to presentation to the next owner, and may also obtain a change request from the maintenance-related business operator (6, 7), and present the recommended maintenance content corrected based on the change request to the next owner (step S108-S118).

Accordingly, it is possible to appropriately modify the recommended maintenance content created based on the vehicle information based on the opinion of the maintenance expert and make the recommended maintenance content more appropriate.

In addition, when the vehicle information associated with the next owner exists (step S102, S104: YES), the maintenance content decision unit (3, 30) may extract a component that needs to be replaced based on the vehicle information of the next owner, and include replacement of the extracted component in the recommended maintenance content (step S108-S110).

As a result, it is possible to recommend replacement and maintenance of parts that may deteriorate within a relatively short period of time to the next owner in advance in consideration of the driving tendency of the next owner.

The aforementioned used vehicle trading support system (1), The confirmation unit (2, 20, step S10) which checks whether the aforementioned vehicles owner has the intention to disclose the aforementioned vehicles (Vo) as the aforementioned used car with the possibility of sale may be included, and the aforementioned information disclosure unit (4, 40), When it is checked that the aforementioned vehicles owner has the intention to disclose the aforementioned vehicles owner (Vo) as the aforementioned used car by the aforementioned confirmation unit (2, 20, step S10), the aforementioned trading establishment determination unit (4, 40) may disclose the aforementioned vehicles owner's desired purchase price (step S50-60) In addition, whether or not the owned vehicle can be sold may be confirmed from the vehicle owner who has received the notification of the desired purchase price (step S70-S80).

As a result, the vehicle owner can know the purchase condition (desired purchase price) of the owned vehicle without conducting business negotiations or the like by using the used vehicle trading support system when he/she thinks that he/she may sell his/her owned vehicle depending on the conditions. As a result, it is possible to improve usability of a vehicle owner who can become a seller of a used vehicle, and to realize smooth trading of the used vehicle.

The used vehicle trading support system (1) may include a vehicle information processing unit (2, 20) that acquires the vehicle information from the plurality of vehicles and stores the vehicle information in a database. The vehicle information processing unit may acquire vehicle information from a plurality of vehicles in order to investigate a cause of a defect occurring in the vehicle, optimize specifications of the components and the vehicle system, and the like.

It is a used vehicle trading support method which supports buying and selling a vehicle owner's owned vehicle (Vo) as a used car using vehicle information obtained from a plurality of vehicles, The aforementioned vehicle owner is disclosed as used car information (step S50-S60), It judges whether the sale and purchase of the aforementioned possession vehicles (Vo) are materialized between the aforementioned vehicle owner and the person who wished to purchase the aforementioned possession vehicles (Vo) (step S70-S80), The maintenance content which should be performed to the aforementioned possession vehicles (Vo) according to the judgment (step S80: YES) of the purport that the sale and purchase of the aforementioned possession vehicles (Vo) were materialized is determined (step S100, S102-S132), and the determined aforementioned maintenance content is maintenance of the aforementioned possession vehicles (Vo) This is a step S200 to be notified to the maintenance-related business operator (6, 7).

According to such a method, it is possible to effectively utilize the period in which the owned vehicle is in the hands of the vehicle owner, and to shorten the time from when the sale is completed between the vehicle owner and the purchase applicant until when the owned vehicle of the vehicle owner is actually delivered to the purchase applicant (the next owner).

It is needless to say that the disclosure of the present disclosure is not limited to the above-described embodiments, and various modifications can be made within the scope of the extension of the present disclosure. Furthermore, the above-described embodiment is only a specific form of the disclosure described in the column of the outline of the disclosure, and does not limit the elements of the disclosure described in the column of the outline of the disclosure.

The disclosure of the present disclosure can be used in a business of selling used vehicles and the like.

What is claimed is:

1. A used vehicle trading support system for supporting trading of an owned vehicle of a vehicle owner as a used vehicle by utilizing vehicle information acquired from a plurality of vehicles, the used vehicle trading support system comprising:
an information disclosure unit for disclosing the vehicle information of the owned vehicle as used vehicle information;
a trading establishment determination unit for determining whether the trading of the owned vehicle is established between the vehicle owner and a purchase applicant who wishes to purchase the owned vehicle by browsing the disclosed vehicle information;
a maintenance content decision unit for deciding maintenance content to be applied to the owned vehicle, based on the vehicle information of the owned vehicle; and
a maintenance content notification unit for notifying a maintenance-related business operator involved in maintenance of the owned vehicle of the maintenance content decided by the maintenance content decision unit, when the trading establishment determination unit determines that the trading of the owned vehicle is established.

2. The used vehicle trading support system according to claim 1, wherein when determination is made that the trading of the owned vehicle is established, the maintenance content decision unit acquires a request related to maintenance from a next owner, and decides the maintenance content based on the acquired request of the next owner.

3. The used vehicle trading support system according to claim 2, wherein the maintenance content decision unit creates recommended maintenance content based on the vehicle information of the owned vehicle, presents the recommended maintenance content to the next owner, and decides the maintenance content based on a request of the next owner with respect to the recommended maintenance content.

4. The used vehicle trading support system according to claim 3, wherein:
the request of the next owner includes a preventive maintenance period of the owned vehicle; and
the maintenance content decision unit extracts a part that needs to be replaced within the preventive maintenance period designated by the next owner, and includes replacement of the extracted part in the maintenance content.

5. The used vehicle trading support system according to claim 3, wherein the maintenance content decision unit presents the recommended maintenance content to the maintenance-related business operator prior to presentation to the next owner, acquires a change request from the maintenance-related business operator, and presents the recommended maintenance content that has been corrected based on the change request to the next owner.

6. The used vehicle trading support system according to claim 3, wherein when there is the vehicle information associated with the next owner, the maintenance content decision unit extracts a part that needs to be replaced based on the vehicle information of the next owner, and includes replacement of the extracted part in the recommended maintenance content.

7. The used vehicle trading support system according to claim 1, further comprising a confirmation unit for confirming whether the vehicle owner intends to disclose the owned vehicle as the used vehicle having a possibility to be sold, wherein:
the information disclosure unit discloses the vehicle information of the owned vehicle when the confirmation unit confirms that the vehicle owner intends to disclose the owned vehicle as the used vehicle; and
the trading establishment determination unit notifies the vehicle owner of a desired purchase price of the purchase applicant, and confirms with the vehicle owner who is notified of the desired purchase price whether to sell the owned vehicle.

8. The used vehicle trading support system according to claim 1, further comprising a vehicle information processing unit for acquiring the vehicle information from the vehicles and storing the vehicle information in a database.

9. A used vehicle trading support method for supporting trading of an owned vehicle of a vehicle owner as a used vehicle by utilizing vehicle information acquired from a plurality of vehicles, the used vehicle trading support method comprising:
disclosing the vehicle information of the owned vehicle as used vehicle information;
determining whether the trading of the owned vehicle is established between the vehicle owner and a purchase applicant who wishes to purchase the owned vehicle by browsing the disclosed vehicle information;
deciding maintenance content to be applied to the owned vehicle in response to a determination that the trading of the owned vehicle is established; and
notifying a maintenance-related business operator involved in maintenance of the owned vehicle of the decided maintenance content.
